(19) United States
(12) Patent Application Publication
(10) Pub. No.: US 2011/0314884 A1
(43) Pub. Date: Dec. 29, 2011

(54) COMBINING BENEFICIAL ASH AND KILN DUST TO PRODUCE MINERAL LIME

(76) Inventors: William B. Spence, Pittsburgh, PA (US); Chris A. Forsha, Blairsville, PA (US)

(21) Appl. No.: 13/168,411

(22) Filed: Jun. 24, 2011

Related U.S. Application Data
(60) Provisional application No. 61/358,696, filed on Jun. 25, 2010.

(51) Int. Cl. C04B 18/06; C05D 9/00

(52) U.S. Cl. 71/62; 106/405; 106/707

(57) ABSTRACT

Mineral Lime is a composition having from about 85% to about 95% by volume of fly ash and from about 5% to about 15% by volume of kiln dust. A composition for Mineral Lime can also have from about 85% to about 95% by volume of Class C fly ash; and from about 5% to about 15% by volume of lime kiln dust. A process for producing a composition of Mineral Lime including fly ash and kiln dust, includes the steps of feeding fly ash to a blender; feeding kiln dust to the blender; and blending the fly ash and kiln dust in the blender.

### CLAIM OF PRIORITY

This application claims priority from Provisional Patent Application Ser. No. 61/358,696 which was filed on Jun. 25, 2010 which is hereby incorporated by reference in its entirety.

### BACKGROUND OF THE DISCLOSURE

The present disclosure relates to a composition comprising fly ash and kiln dust to produce Mineral Lime. It finds particular application in conjunction with soil additives, and will be described with particular reference thereto. However, it is to be appreciated that the present exemplary embodiment is also amenable to other like applications, such as use as an additive to cement or concrete.

Fly ash is a residue produced during the combustion of coal. Compositions of fly ash vary significantly but fly ash is generally rich in both silicon dioxide (SiO₂) and calcium oxide (CaO). Fly ash may also include toxic components such as arsenic, beryllium, boron, cadmium, chromium, cobalt, lead, manganese, mercury, molybdenum, selenium, strontium, thallium, vanadium, dioxins, and/or polycyclic aromatic hydrocarbons. Fly ash is a regulated substance because of these toxic materials. In the soil additive context, metal loading of the soil can be particularly problematic.

Classes of fly ash include Class F fly ash and Class C fly ash. Class F fly ash is typically produced by burning harder, older anthracite and bituminous coal. Class F fly ash typically contains less than 10% CaO. Class C fly ash is typically produced by burning younger lignite or sub bituminous coal. Class C fly ash generally contains more than 20% CaO. Additionally, alkali and sulfate contents are generally higher in Class C fly ash than in Class F fly ash.

Kiln dust is a byproduct formed in a kiln during a manufacturing process. Cement kiln dust is formed during the manufacture of cement while lime kiln dust is formed during the manufacture of lime. Kiln dust is highly alkaline and is generally in the form of very fine particles. Kiln dust is a regulated material because of ambient dust concerns, e.g. respiratory problems in humans and animals, due to its small particle size.

Compositions comprising fly ash and kiln dust are known for use such as in cement mixtures and for treating sludge and other industrial wastes. Fly ash and kiln dust are also known soil additives. Soil additives may be added to soil in very large quantities and monitoring is required. However, soil additives containing fly ash and/or kiln dust typically lead to undesirable metal loading and/or ambient dust concerns.

Some companies which produce combinations of kiln dust or fly ash include Pitt Mining Biosolids which sells a blend of sewage sludge and kiln dust. Harsco Minerals sells a product called Mineral CSA's product which is produced by blending a ground steel slag with a bag-house lime. The Alkaline Neutralizing Equivalents of Pitt Mining Biosolids' product and Mineral CSA's product are 90% and 88%, respectively.

There exists a need for combining beneficial ash with kiln dust to produce Mineral Lime, while overcoming the above-mentioned deficiencies and others, while providing better and more advantageous overall results. There also exists a need to add alkaline to beneficial ash to reduce metals release.

There remains a need for a soil additive composition which contains nutrients for the growth of healthy vegetation. In particular, there remains a need for a composition that includes fast acting alkalinity for starting growth and slow release alkalinity for maintaining vegetation without the deficiencies associated with fly ash and kiln dust. Also, there is a need for a composition for soil stabilization.

### SUMMARY OF THE DISCLOSURE

In accordance with one aspect of the disclosure, a blend of co-products called Mineral Lime is made which exceeds specifications outlined for lime products marketed for agricultural and home use. In accordance with one aspect of the disclosure, Mineral Lime is a blend of fly ash and kiln dust. It is important to note that each of these products by themselves has less than attractive attributes. Combined, they can produce a Mineral Lime with beneficial properties as discussed below.

Fly ash is a regulated material which is monitored due to the metals loading of the soils. This is required because the primary use of fly ash has been for fill material and or soil conditioning. Both of these processes tend to involve large amounts of material and monitoring is required. Kiln dust is very alkaline in composition but a very fine material which is controlled to minimize the ambient dust concerns associated with this product.

Blending of the fly ash and kiln dust, which previously were intended to be disposed of, creates a mineral rich alkaline product, i.e. Mineral Lime, which contains essential nutrients for the growth of healthy vegetation. The Mineral Lime also contains fast acting and slow release alkalinity which is perfect for starting and maintaining vegetation. The Mineral Lime also aids in soil stabilization.

The key to the success of the Mineral Lime is that the application rate is based on the alkalinity requirements. This eliminates the concern in regard to exceeding the metals loading limits established by regulatory agencies and at the same time makes these minerals and metals available as nutrients for vegetation.

Calculations show the metals loading for this product is limited to 143.50 tons per acre under the limits established for Arsenic; however, the alkaline requirements limits the application rate to 2 tons per acre or 1.39% of the metals loading limit. Due to this built-in safety factor, this product can be used for unrestricted public sale on a national basis.

A preferred source of the fly ash is the Scrubgrass Generating Facility, which is approved for beneficial use for fill material, alkaline addition and soil enhancement certification # CA007. Scrubgrass monitors the metals limit on a quarterly basis. A preferred source for the kiln dust is Graymont Inc. of Pleasant Gap, Pa.

Similar blending processes have been approved for unrestricted public sale for the same reasons as described herein. Pitt Mining Biosolids uses a blend of Sewage Sludge and Kiln dust, while Harsco Minerals produces a ground steel slag blended with bag-house lime to form a product called CSA. The Alkaline Neutralizing Equivalent for Pitt Mining was 90%, CSA was 88%, whereas Mineral Lime is 90.84% and is derived from stable monitored sources.

In accordance with another aspect of the disclosure, the process begins with the delivery of kiln dust by a pneumatic tanker and the kiln dust is transferred to a 50-ton silo. The 50-ton silo is equipped with a bag house air filtering device which serves as the air control for the entire process. The atmosphere in the process building is re-circulated through this device and automatic shakers deposit the captured kiln dust into the silo for use in the process.

Fly ash is deposited into a receiving bin and fed onto a transfer belt which is enclosed and connected to an air recirculation system.

Kiln dust in turn is auger fed to an enclosed belt and is deposited on to the fly ash at a controlled rate to equal five times the volume carried by the transfer belt.

In accordance with another aspect of the disclosure, a process for producing the composition is also disclosed. Kiln dust and fly ash are fed to a blender. In the blender, the kiln dust and fly ash are blended to form the composition of the present disclosure.

Both materials, i.e. the kiln dust and fly ash, then enter a blender which is connected to an air quality control device. Both materials are blended and discharged on to the radial belt where the material will be discharged to a bulk stock pile or will be directed to bagger equipment. The material directed to bagger equipment is preferably packaged into 40-lb. bags and placed onto pallets of about 50 bags per pallet, then wrapped with packing plastic wrap. The pallets are then stored until shipping. The bulk material is typically stored under cover until shipping.

In accordance with still another aspect of the present disclosure, the fly ash may comprise Class C fly ash, Class F fly ash, or a mixture thereof. The kiln dust may comprise cement kiln dust, lime kiln dust, or a mixture thereof.

In accordance with another aspect of the disclosure, processes are disclosed for adding the composition to soil to achieve beneficial effects such as soil stabilization.

In accordance with another aspect of the disclosure, Mineral Lime has been developed as a replacement for limestone aggregate material in cement and concrete products. The consistency, strength and availability of Mineral Lime far exceed that of aggregate materials.

In accordance with one aspect of the disclosure, Mineral Lime is a composition comprising from about 5% to about 15% by volume of kiln dust and from about 85% to about 95% by volume of fly ash.

In accordance with another aspect of the disclosure, a composition for Mineral Lime comprises from about 5% to about 15% by volume of lime kiln dust; and from about 85% to about 95% by volume of Class C fly ash.

In accordance with another aspect of the disclosure, a process for producing a composition of Mineral Lime comprising fly ash and kiln dust, the process includes feeding fly ash to a blender; feeding kiln dust to the blender; and blending the fly ash and kiln dust in the blender; wherein the composition comprises from 5% to 15% by volume of the kiln dust and from 85% to 95% by volume of the fly ash.

Still other features and benefits of the present disclosure will become apparent from the following detailed description.

### BRIEF DESCRIPTION OF THE DRAWINGS

The following is a brief description of the drawings, which are presented for the purposes of illustrating the exemplary embodiments disclosed herein and not for the purposes of limiting the same.

FIG. 1 illustrates a flow chart for a process in accordance with the present disclosure for producing a blend of fly ash and kiln dust to produce Mineral Lime.

FIGS. 2 and 3 are tables containing data for soil to which an exemplary blend of 95% by volume fly ash and 5% by volume kiln dust have been added; and

FIG. 4 is a chart showing the relative amounts of various components and the alkaline neutralizing equivalent of the exemplary blend of 95% fly ash and 5% kiln dust.

### DETAILED DESCRIPTION OF THE DISCLOSURE

A more complete understanding of the components, processes, and apparatuses disclosed herein can be obtained by reference to the accompanying drawings. These figures are merely schematic representations based on convenience and the ease of demonstrating the present disclosure, and are, therefore, not intended to indicate relative size and dimensions of the devices or components thereof and/or to define or limit the scope of the exemplary embodiments.

Although specific terms are used in the following description for the sake of clarity, these terms are intended to refer only to the particular structure of the embodiments selected for illustration in the drawings, and are not intended to define or limit the scope of the disclosure.

The modifier “about” used in connection with a quantity is inclusive of the stated value and has the meaning dictated by the context (for example, it includes at least the degree of error associated with the measurement of the particular quantity). When used in the context of a range, the modifier “about” should also be considered as disclosing the range defined by the absolute values of the two endpoints. For example, the range of “from about 2 to about 10” also discloses the range “from 2 to 10.”

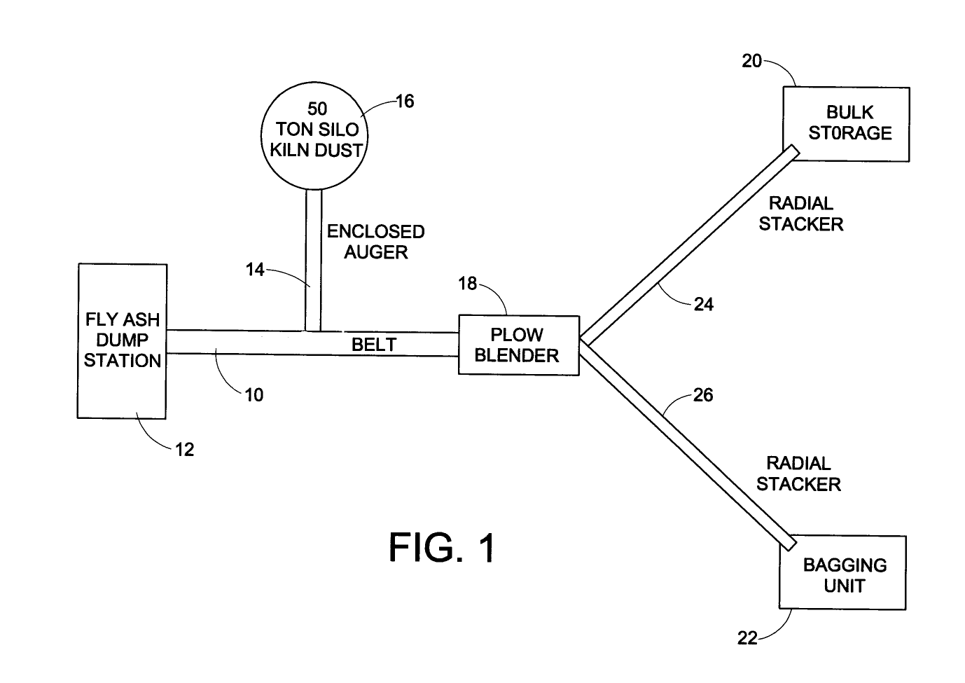

Referring now to FIG. 1, in accordance with a preferred embodiment of the disclosure, a process of combining fly ash and kiln dust to produce Mineral Lime is shown. Fly ash is fed to a transfer belt 10 from a fly ash dump station 12. The transfer belt may be enclosed and connected to an air-recirculation system. Kiln dust is also fed to the transfer belt. The kiln dust may be fed to the transfer belt via an enclosed auger 14 from a silo 16 holding up to about 50 tons of kiln dust. Both materials on the transfer belt are then transferred to a plow blender 18. The blender may also be connected to an air-recirculation system. The contents of the blender are blended and then discharged to radial belts. The blend may be fed to bulk storage 20 or a bagging unit 22 via radial stackers 24, 26.

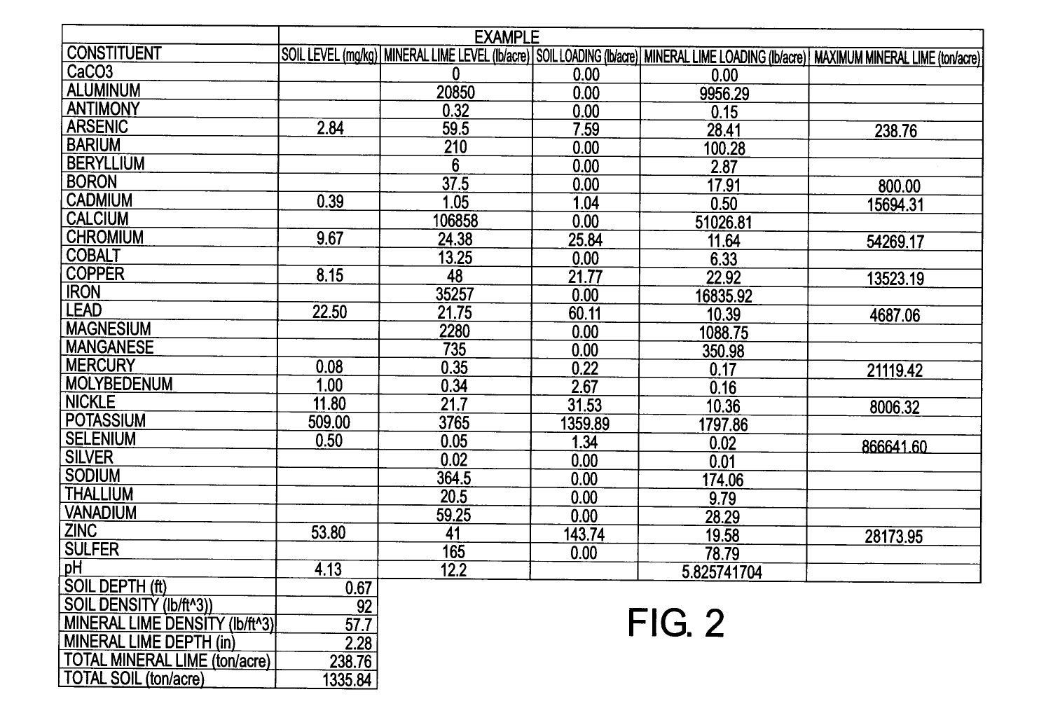

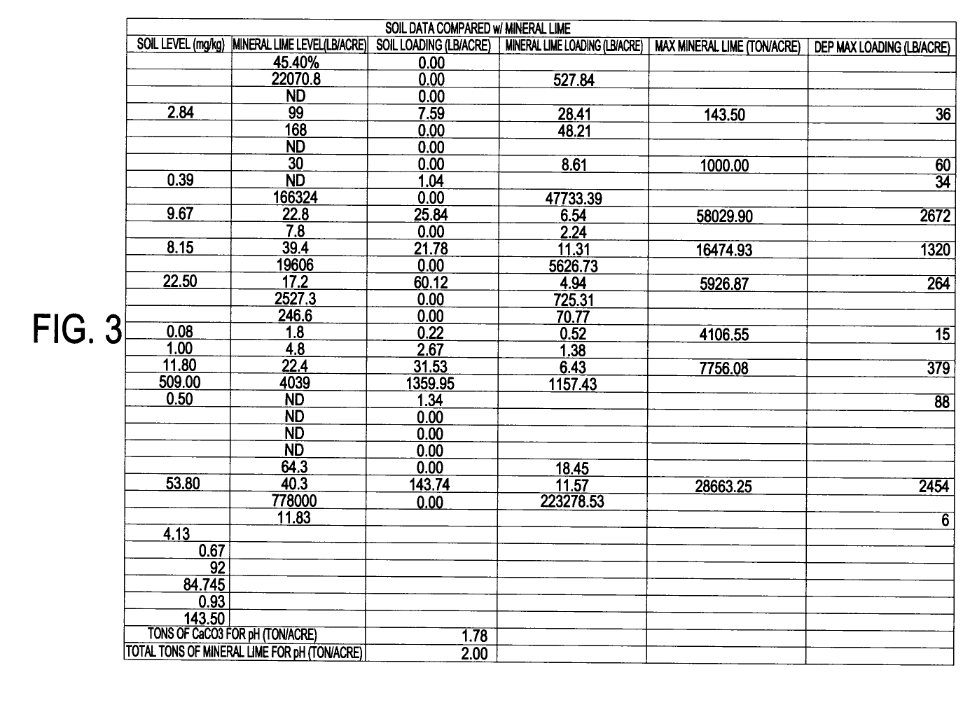

In some embodiments, a portion of the blend is sent to bulk storage 20 while the remainder is sent to the bagging unit 22. At the bagging unit, the blend may be packaged into bags, such as 40 pound bags. The bags may be stacked onto pallets of about 50 bags and wrapped with plastic packing wrap. Other sizes and amounts of bags are also contemplated by the disclosure. The portion sent to bulk storage may be stored under cover until ready for bagging and shipping. The fly ash may comprise about 95% by volume of the material on the transfer belt. The kiln dust may comprise the remaining 5% by volume of the material on the transfer belt. The preferred 95:5 ratio of volume for the Mineral Lime is the least amount to have an equivalent calcium carbonate level comparable to agricultural lime. (See FIGS. 2 and 3.)

The fly ash may be Class F fly ash, Class C fly ash, or a mixture thereof. In some embodiments, the fly ash may be present in an amount of from about 85% to about 95% of the total composition volume. Mineral Lime preferably contains class “C” fly ash, since Class “F” fly ash contains higher concentrations of metals and is lower in calcium carbonate content.

The kiln dust may be cement kiln dust, lime kiln dust, or a mixture thereof. Lime kiln dust is preferred, which is the dust collected of the kilns which produce hydrated lime, a very high alkaline material. Cement kiln dust is the dust collected from grinding the manufactured “klingers” used to produce cement. In some embodiments, the kiln dust may be present in an amount of from about 5% to about 15% of the total composition volume. In some embodiments, the kiln dust is high calcium lime kiln dust as produced by Graymont in Pleasant Gap, Pa.

In the preferred embodiment, the composition may consist of only fly ash and kiln dust. Alternatively, the disclosure contemplates additives may be included in the composition.

The established limit for arsenic in soil is 143.50 tons per acre. When the blend of the present disclosure is used as a soil additive, the level of arsenic in the soil is limited to only 2 tons per acre. This represents only 1.39% of the metals loading limit.

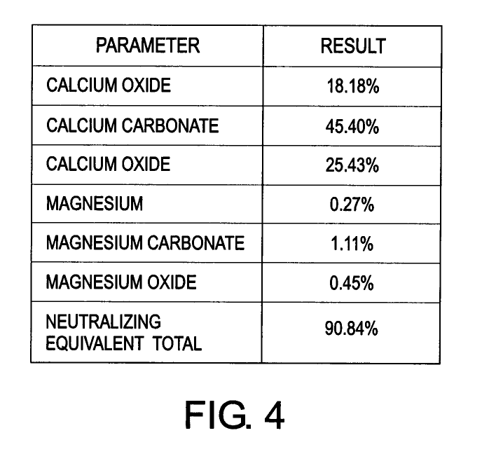

The disclosed composition contains essential nutrients for the growth of healthy vegetation, particularly fast acting alkalinity that is perfect for starting growth and slow release alkalinity that is perfect for maintaining vegetation. Compositions of the present disclosure exhibit superior alkalinity-related properties. In particular, a blend of 95% by volume fly ash and 5% by volume kiln dust has an alkaline neutralizing equivalent of about 90.84% as shown in FIG. 4. A neutralizing equivalent reduces acid in soil or the product.

Methods for adding the disclosed compositions to soil to promote growth of healthy vegetation and soil stabilization are also disclosed. The pH levels of the Mineral Lime will vary as to the alkalinity of the soil where it is being applied.

Whereas Mineral Lime has been primarily developed for alkaline addition in soils and soil stabilization, Mineral Lime also serves as a replacement for limestone aggregate material in cement and concrete products. The consistency, strength and availability of Mineral Lime far exceed that of aggregate materials. Typical products which are improved by the use of Mineral Lime in lieu of aggregate materials include, but are not limited to: facing stone, retaining wall block, cement brick, paving stone, patio stone, cement pottery, cement patio furniture, parking stops, concrete barriers, concrete footers, cement floors and mortar.

The use of Mineral Lime in these applications increases strength reduced shrinkage and reduces the amount of cement required in the mixture formula. Mineral Lime provides a low cost superior material to replace aggregate material. Portland and similar cements react with water (hydrate) to create a gel that hardens by absorbing carbon dioxide. As it hardens, the cement binds aggregates (typically sand and crushed stone) together, creating concrete. When Portland cement cures, it leaves behind some hydrated lime. Adding Mineral Lime allows that hydrated lime to cure as well (as in the Roman walls), making the concrete stronger and less porous.

Mineral Lime also increases the durability of concrete and can also be used to shrink its environmental footprint by reducing the amount of Portland cement in the mix. Nearly a ton of carbon dioxide is emitted to produce each ton of Portland cement. Mixes in which up to 25% of the cement is replaced by Mineral Lime are being developed, and some designers are specifying over 50% substitution for certain applications. Typically, the peak stress of cement or concrete is about 2,000 psi. Compositions including 40% to 50% of Mineral Lime can withstand peak stresses of from 1,988 to 3,540 psi. For example, a composition of 40% Mineral Lime, 40% sand, and 20% Portland cement can withstand a peak load of 7,950 lbs. and a peak stress of 1,988 psi. A composition of 50% Mineral Lime, 40% sand, and 10% Portland cement withstood a peak load of 663 lbs. and a peak stress of 166 psi. A composition of 40% Mineral Lime, 40% sand, and 20% Portland cement (coated) withstood a peak load of 9,390 lbs. and 2,348 psi. A composition of 40% Mineral Lime, 40% Red Dog and 20% Portland cement (coated) withstood a peak load of 14,160 lbs. and a peak stress of 3,540 psi.

The exemplary embodiments have been described with reference to the preferred embodiments. Obviously, modifications and alterations will occur to others upon reading and understanding the preceding detailed description. It is intended that the exemplary embodiments be construed as including all such modifications and alterations.

1. A composition for Mineral Lime comprising:
from about 85% to about 95% by volume of fly ash; and
from about 5% to about 15% by volume of kiln dust.

2. The composition of claim 1, wherein the fly ash is Class C fly ash.

3. The composition of claim 1, wherein the kiln dust is lime kiln dust.

4. The composition of claim 1, wherein the composition comprises about 95% by volume of fly ash.

5. The composition of claim 1, wherein the composition comprises about 5% by volume of kiln dust.

6. The composition of claim 1, wherein the composition has a neutralizing equivalent of at least 90.84%.

7. The composition of claim 1, wherein the volumetric ratio of fly ash to kiln dust is about 19:1.

8. A process for promoting growth of healthy vegetation in soil comprising:
providing the composition of claim 1 to the soil.

9. A product comprising the composition of claim 1.

10. The product of claim 9, wherein the product is a facing stone, a retaining wall block, a cement brick, a paving stone, a patio stone, cement pottery, cement patio furniture, a parking stop, a concrete barrier, a concrete footer, a cement floor, or a mortar.

11. The composition of claim 1, further comprising:
at least one additive.

12. The composition of claim 1, wherein the composition consists of fly ash and kiln dust.

13. A composition for Mineral Lime comprising:
from about 85% to about 95% by volume of Class C fly ash; and
from about 5% to about 15% by volume of lime kiln dust.

14. The composition of claim 13, wherein the composition consists of about 95% by volume of Class C fly ash and about 5% by volume of lime kiln dust.

15. The composition of claim 14, wherein the composition has a neutralizing equivalent of at least 90.84%.

16. A process for producing a composition of Mineral Lime comprising fly ash and kiln dust, the process comprising:
feeding fly ash to a blender;
feeding kiln dust to the blender; and
blending the fly ash and kiln dust in the blender;
wherein the composition comprises from 85% to 95% by volume of the fly ash and from 5% to 15% by volume of the kiln dust.

17. The process of claim 16, wherein the fly ash and kiln dust are fed to the blender via a transfer belt.

18. The process of claim 17, wherein the fly ash is provided to the transfer belt via a dump station and the kiln dust is provided to the transfer belt via a silo.

19. The process of claim 16, wherein the fly ash is Class C fly ash; and wherein the kiln dust is lime kiln dust.

20. The process of claim 16, wherein the composition consists of the fly ash and the kiln dust.
